(19) United States
(12) Patent Application Publication
(10) Pub. No.: US 2019/0172028 A1
(43) Pub. Date: Jun. 6, 2019

(54) Leverage Immediate Payments for Online or POS Retail Sales

(71) Applicant: International Business Machines Corporation, Armonk, NY (US)

(72) Inventors: Sean Dunne, Blackrock (IE); Michael J. Hudson, Delray Beach, FL (US)

(21) Appl. No.: 15/828,714

(22) Filed: Dec. 1, 2017

(51) Int. Cl. G06Q 20/08; G06Q 20/32; G06Q 20/02

(52) U.S. Cl. CPC G06Q 20/0855; G06Q 20/02; G06Q 20/3223

(57) ABSTRACT

An approach is disclosed that has a merchant receive a purchase request that includes a purchase amount. The merchant creates a payment template that includes the purchase amount and the merchant's bank account information. The payment template is provided the customer, and then the merchant receives a completion notification of the purchase request from a trusted third party, such as the merchant's financial institution.

### BACKGROUND

Traditional online and point-of-sale (POS) consumer payment systems often use credit or debit cards to initiate payment for goods and services desired by the consumer. These traditional payment systems pose challenges for the consumers, the merchants, as well as for the banks that issue the credit and debit cards. For consumers, the traditional system is risky in that the consumer is forced to disclose payment details needed to initiate the payment to the merchant. Employees of the merchant and other malevolent parties often copy, and thereby steal, the consumer's credit or debit card information in order to make fraudulent charges on the consumer's credit or debit card. This can result in damaged credit to the consumer. Banks that issue the credit and debit cards typically insure the consumer against such fraudulent charges, leaving the banks exposed to losses for such fraud when credit and debit card numbers are exposed. Traditional systems are also challenging to the merchant because of the added transactional cost when a customer uses a credit or debit card, with the transactional cost often being a percentage of the purchase price. In addition, when using traditional credit and debit card systems, the merchant has to often wait several days for the credit card settlement to occur and for the merchant to receive funds from the purchase.

### SUMMARY

An approach is disclosed that has a merchant receive a purchase request that includes a purchase amount. The merchant creates a payment template that includes the purchase amount and the merchant's bank account information. The payment template is provided the customer, and then the merchant receives a completion notification of the purchase request from a trusted third party, such as the merchant's financial institution.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting transactional flows between the customer, the retailer, and the banks in a manner that provides near-immediate payments to the retailer without having the retailer receive any customer account details that would otherwise be needed to initiate the payment;

FIG. 4 is a flowchart depicting the near-immediate payment system as seen from a customer's perspective when purchasing goods or services; and

FIG. 5 is a flowchart depicting the near-immediate payment system as seen from a retailer's perspective when a customer is purchasing goods or services from the retailer.

### DETAILED DESCRIPTION

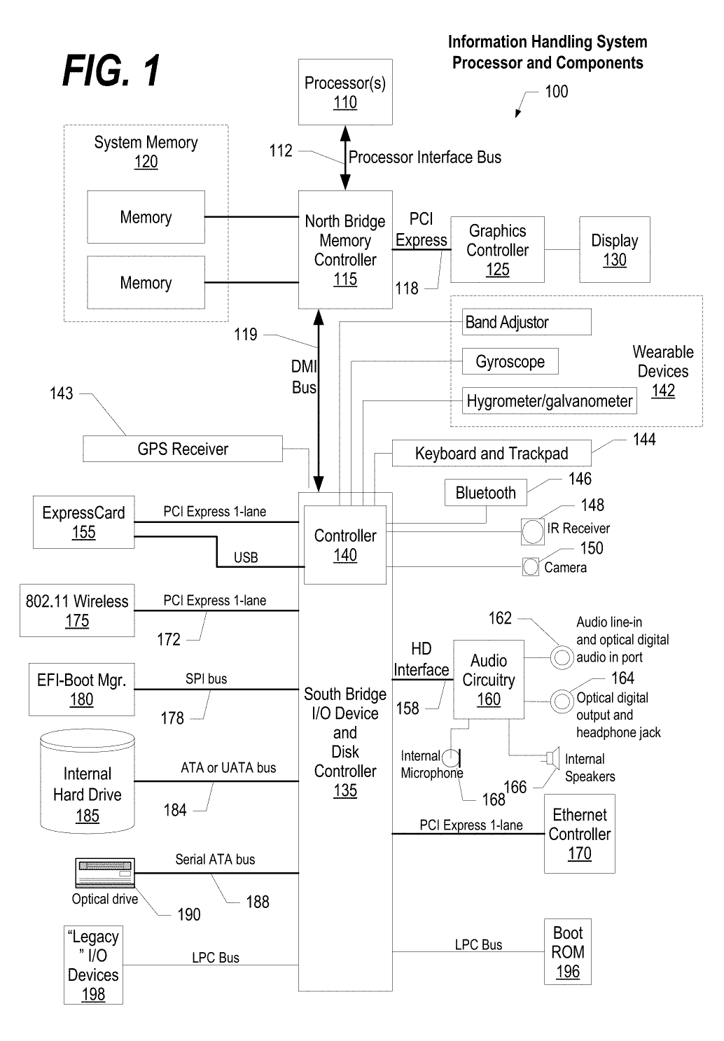

FIGS. 1-5 show an approach whereby the mobile/e-Commerce vendor creates a payment ‘template’ that the customer uses in conjunction with his financial institution's mobile or web interface to initiate a secure immediate payment credit transfer. Different embodiments of the approach may be used for either online payments or in-store point of sale (POS) payments. Advantages of the system include improved customer security with customers no longer needing to disclose their banking details that would allow the merchant, or any others, from initiating a payment from the customer's account. Retailer speed is also improved with retailers receiving immediate value for the funds. Financial institution risk is also lowered as these institutions have reduced exposure to the risk associated with online payments and credit card fraud.

The approach is keyed on the creation of a payment ‘template’ that includes the merchant's financial account information, any needed bank routing information, and a purchase reference identifier. Online banking software to consume the purchase template and ‘fill in the blanks’ with the customer's account and routing information that completes the template. The completed template is transmitted to the customer's financial institution that transfers funds from the customer's account to the merchant's account. When funds are received at the merchant's financial institution, the financial institution notifies the merchant of the transfer of funds with the notification including the merchant created reference number that is used to track the transaction.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

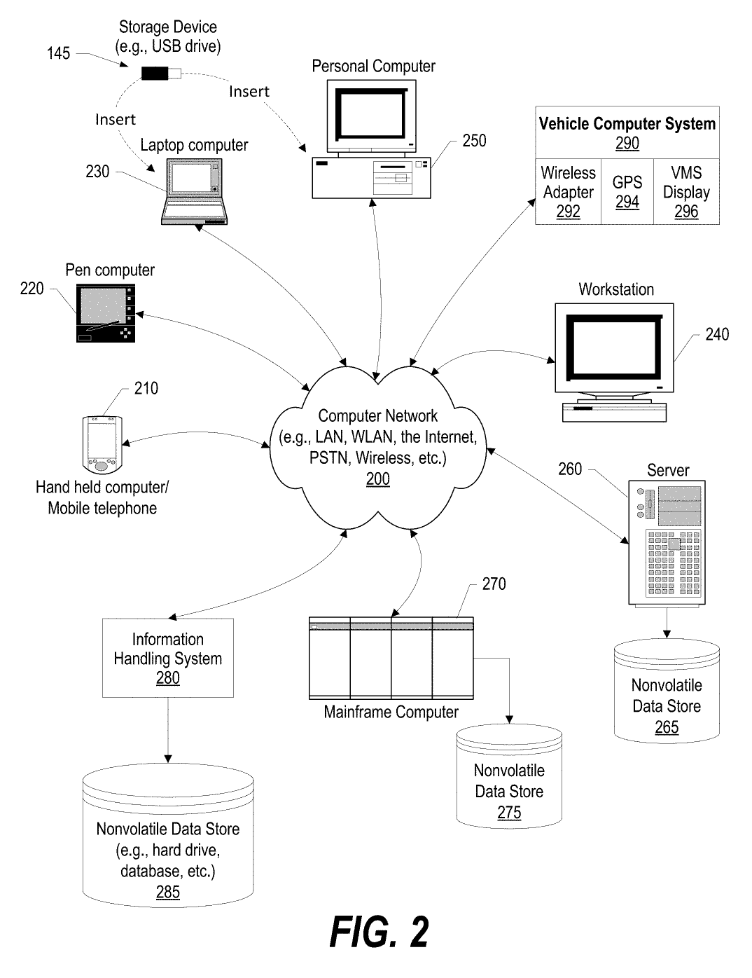

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

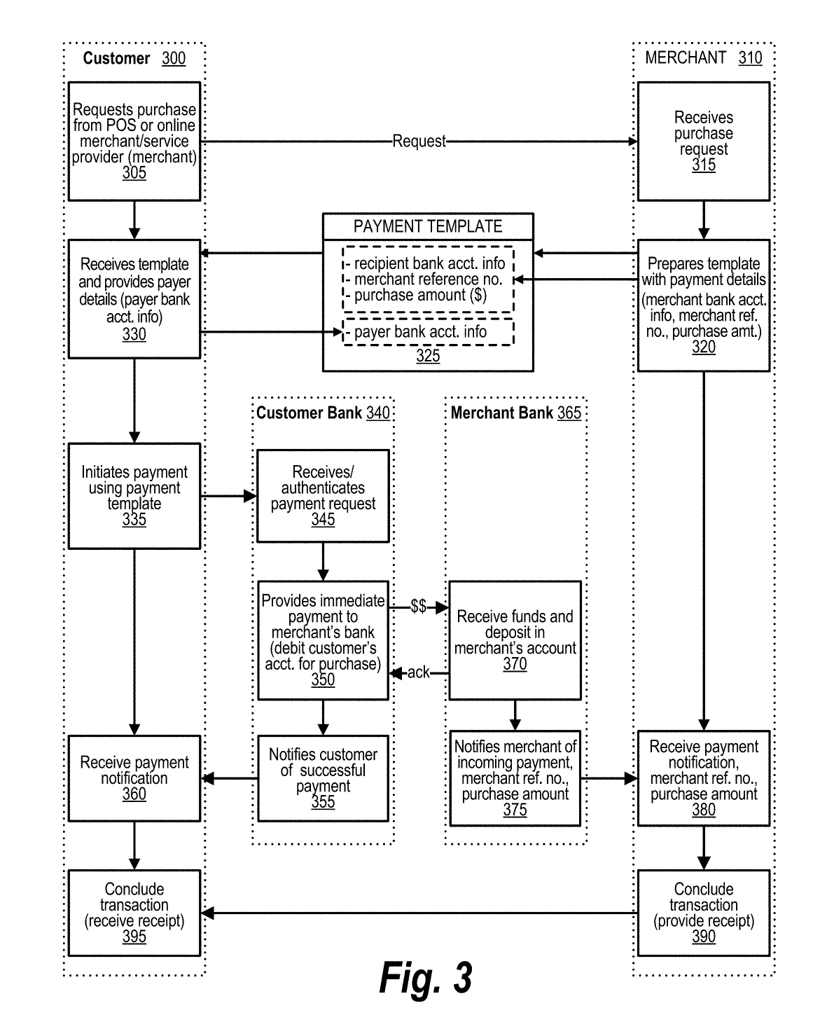

FIG. 3 is a component diagram depicting transactional flows between the customer, the retailer, and the banks in a manner that provides near-immediate payments to the retailer without having the retailer receive any customer account details that would otherwise be needed to initiate the payment. Customer processing is shown enclosed in box 300 with some customer steps interacting with the merchant and with the customer's financial institution, such as a bank. Likewise, merchant processing is shown enclosed in box 310 with some merchant steps interacting with the customer and with the merchant's financial institution, such as a bank. Note that the merchant processing does not interact directly with the customer's financial institution and, consequently, the merchant is never able to initiate a payment directly from the customer's financial institution.

Customer financial institution processing is shown enclosed in box 340 with some of the customer financial institution steps interacting with the customer and some processing interacting with the merchant's financial institution. Note that in the embodiment shown, the customer's financial institution does not interact directly with the merchant. Instead, the customer's financial institution interacts with the merchant's financial institution that acts as a trusted third party on behalf of the merchant. Finally, the merchant's financial institution is shown enclosed by box 365 with the merchant's financial institution interacting with the customer's financial institution and with the merchant. In the embodiment shown, the merchant's financial institution does not interact directly with the customer.

Starting with customer processing 300, at step 305, the customer submits a purchase request to the merchant. The purchase request can be an electronic purchase request, such as when the customer is utilizing the merchant's web site and requests to purchase items found on the merchant's web site. In a point-of-sale (POS) transaction the items would be scanned, etc. at a checkout in a traditional retail environment. The communication with the customer device would occur after the customer selects this new payment method, creating the need for the system to communicate the payment template to the customer device in step 325.

Moving to merchant processing, at step 315, the merchant receives the purchase request submitted by the customer, such as at the merchant's web site or at a checkout, as described above. At step 320, a merchant process prepares payment template 325 with the payment template including payment details such as the merchant's bank account information where the funds are to be deposited, a merchant reference number, such as a unique identifier, that is used to track the payment, and a purchase amount corresponding to the goods and/or services that are being purchased by the customer.

Returning to customer processing, at step 330, the customer process receives payment template 325 from the merchant and the customer provides payment details such as the customer's financial institution and the customer's account number at the financial institution from which funds are to be transferred to the merchant as payment satisfying the purchase request. At step 335, a customer process initiates payment with the customer's financial institution using information included in payment template 325 to instruct the customer's financial institution of the merchant's financial institution and account number (provided by the merchant in the payment template), the purchase amount (also provided by the merchant in the payment template), the merchant's reference number (again, provided by the merchant in the payment template), and the customer's account number information (provided by the customer). In one embodiment, the payment template is transmitted to the customer's financial institution while, in another embodiment, the information included in the payment template is used to automatically request a payment transfer from the customer's account at the customer's financial institution to the merchant's account at the merchant's financial institution. In one embodiment, the customer authenticates himself/herself with the customer's financial institution using traditional means such as a PIN code, a user identifier and password (e.g., from a web site of the customer's financial institution, etc.), a biometric signature (e.g., the customer's fingerprint, etc.), or other means of authenticating the customer to the customer's financial institution.

Moving to customer financial institution processing, at step 345, the customer's financial institution receives and authenticates the payment request to ensure that the customer has authorized the payment of funds from the customer's account to the merchant's account at the merchant's financial institution. At step 350, the customer's financial institution provides near-immediate payment to the merchant's financial institution using established inter-bank transfer of funds methods. The customer's financial institution also subtracts (debits) the amount of the purchase from the customer's account that is maintained by the customer's financial institution. At step 355, the customer's financial institution notifies the customer that the funds were successfully transferred to the merchant's account at the merchant's financial institution. In one embodiment, the notification also includes the merchant's reference number, the payment amount, and other information regarding the merchant's account to which the funds were transferred.

Returning to customer processing, at step 360, the customer receives the payment notification, such as via a text message on the customer's mobile device during a POS transaction or via a message or email to the customer if the transaction is an Internet transaction where the customer purchased items from the merchant's web site.

Turning now to merchant financial institution process 365, at step 370, the merchant's financial institution receives funds from the customer's financial institution and deposits the funds in the merchant's account as the merchant's account information, reference number, and payment amount was included in the transfer request from the customer's financial institution. At step 375, the merchant's financial institution notifies the merchant of the incoming payment with the notification including the merchant reference number and the purchase amount indicating the amount of funds that were deposited in the merchant's account.

Turning to merchant processing, at step 380, the merchant process receives the payment notification that includes the merchant reference number and the purchase amount indicating the amount of funds that were deposited in the merchant's account. The merchant matches the merchant reference number received in the notification to the merchant reference number included in the payment template that was generated by the merchant in order to match the payment that was received to the customer and the customer's purchase request. At step 390, the merchant process concludes the transaction by notifying the customer corresponding to the merchant reference number. In one embodiment, the notification is a receipt that details the purchase request and evidences that payment was received from the customer to satisfy the purchase request. Embodiments that use the new Real-Time/Instant/Immediate payment schemes, steps 345 through 355 (including 370, 375) will often complete within a few seconds and will almost always complete in under a minute (sixty seconds).

Finally, turning again to customer processing, at step 395, the purchase request process is concluded when the customer receives the notification (receipt) from the merchant that shows that the customer has provided payment for the purchase request.

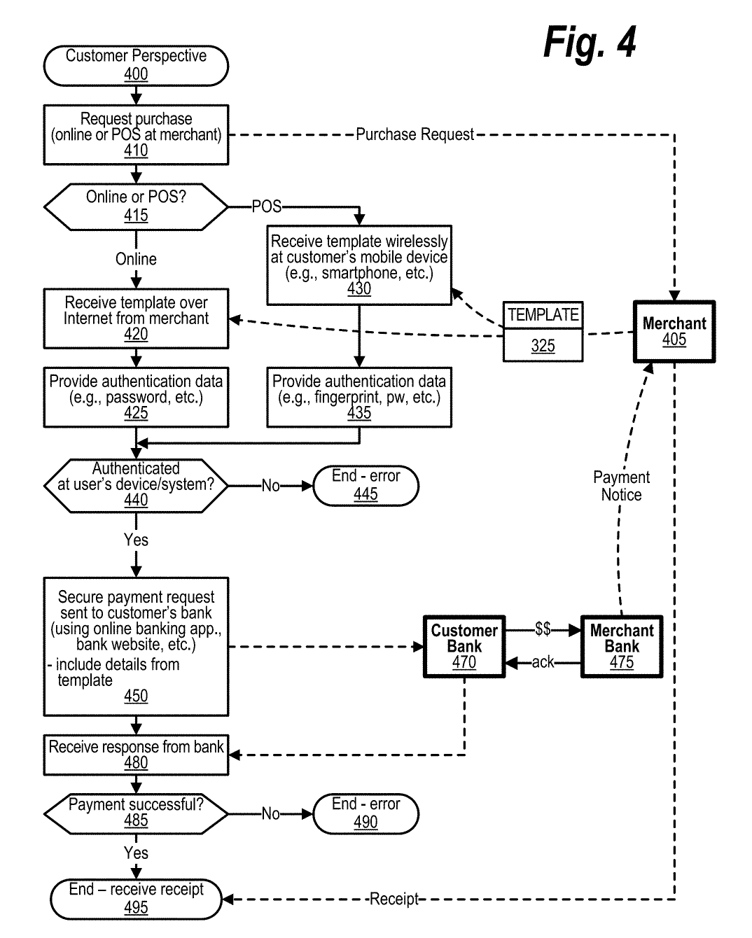

FIG. 4 is a flowchart depicting the near-immediate payment system as seen from a customer's perspective when purchasing goods or services. FIG. 4 processing commences at 400 and shows the steps taken to leverage immediate payments from the customer's perspective. At step 410, the customer requests a purchase from merchant 405, such as an online transaction from the merchant's web site or a point-of-sale (POS) transaction at a physical location of merchant 405. The process determines whether the transaction is an online transaction or a POS transaction (decision 415). If the transaction is an online transaction, then decision 415 branches to the ‘online’ branch to perform steps 420 and 425. At step 420, the process receives payment template 325 over the Internet connection between the customer's computing device and the merchant's web site. At step 425, the customer provides authentication data used to access the customer's account at the customer's financial institution, such as a user identifier and password, used to access the customer's online account.

Returning to decision 415, if the transaction is a POS transaction, then decision 415 branches to the ‘POS’ branch to perform steps 430 and 435. At step 430, the customer receives payment template 325 wirelessly at the customer's device, such as a mobile device, smart phone, etc. In one embodiment, step 325 could be the device scanning a bar code or QRcode displayed on the POS terminal. Another embodiment uses a wireless transmission, such as NFC, or even as an SMS text message, to communicate with the customer device. At step 435, the customer provides authentication data used to authenticate that the customer has approved the purchase described in payment template 325. In one embodiment, the authentication data is biometric data, such as a fingerprint, unique to the customer. In another embodiment, the authentication data is a PIN code used to access the user's financial account.

The process determines the user was successfully authenticated at the user's device or system (decision 440). If the user was not successfully authenticated, then decision 440 branches to the ‘no’ branch whereupon processing ends at 445 noting an authentication error. On the other hand, if the user was successfully authenticated, then decision 440 branches to the ‘yes’ branch to continue processing the payment.

At step 450, the process transmits a secure (e.g., encrypted, etc.) payment request to the customer's financial institution using data from the payment template that includes the payment amount, the merchant's financial institution and account information, and the merchant's reference number. In one embodiment, the transmission is made using an online banking application provided by the customer's financial institution or from a bank website to which the customer can access from the customer's device. At step 480, the customer's device receives a response from the customer's financial institution indicating whether the payment request was successful (e.g., sufficient funds in customer's account to satisfy purchase request, etc.). The process determines whether the payment was successful (decision 485). If the payment was unsuccessful, then decision 485 branches to the ‘no’ branch whereupon at 490 processing ends with an error indicating that the payment was unsuccessful. On the other hand, if the payment was successful, then decision 485 branches to the ‘yes’ branch whereupon processing ends successfully at 495 and, in one embodiment, the customer receives a notification, such as a receipt, from the merchant indicating that the purchase was successfully completed.

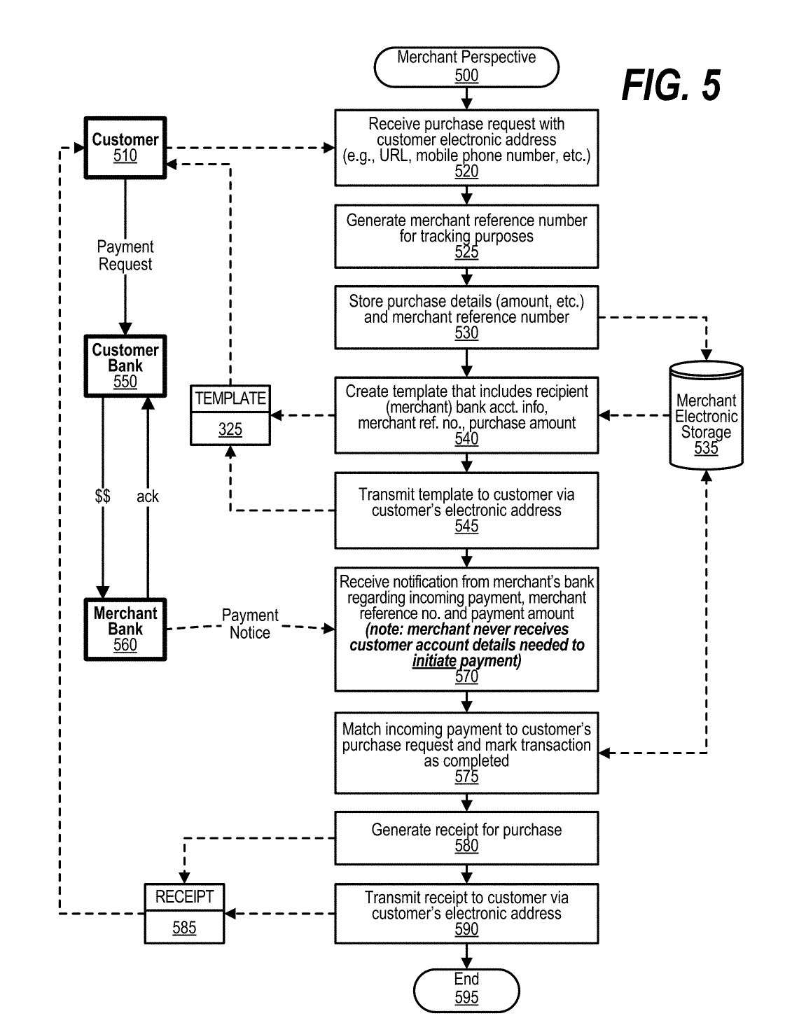

FIG. 5 is a flowchart depicting the near-immediate payment system as seen from a retailer's perspective when a customer is purchasing goods or services from the retailer. FIG. 5 processing commences at 500 and shows the steps taken to leverage immediate payments from the merchant's perspective At step 520, the process receives a purchase request along with the customer's electronic address (e.g., URL, mobile phone number, etc.) from customer computing device 510. The customer's electronic address is used by the merchant to send the payment template and notifications (e.g., receipt, etc.) the customer. As previously described, this communication might use NFC or SMS text messaging to communicate with the customer's device.

At step 525, the merchant's process generates a merchant reference number, such as a unique identifier, with the merchant reference number being used by the merchant to track the payment of the purchase request through the system. At step 530, the merchant process stores the purchase details and the merchant reference number in data store 535. The purchase details include the purchase amount and the customer's electronic address used to communicate with the customer.

At step 540, the merchant process creates payment template 325 that includes the merchant's bank account information including the merchant's financial institution information or identifier, the merchant reference number, and the purchase amount. At step 545, the merchant process transmits payment template 325 to the customer using the customer's electronic address that was provided when the merchant received the purchase request. In one embodiment, a previously stored electronic address may not be required in an embodiment where the customer device scans/reads a bar code or QRcode.

At step 570, the merchant's process receives a notification from the merchant's bank regarding an incoming payment along with the merchant reference number, and the payment amount. Note that the merchant never receives customer account details that would be needed to initiate a payment on behalf of the customer. At step 575, the merchant process matches the merchant reference number included in the incoming payment information to a set of customer purchase requests stored in data store 535 and the process marks the payment transaction as being completed. At step 580, the process generates receipt 580 corresponding to the purchase. The receipt includes information from payment template 325 along with a description of the goods and/or services purchased, the payment amount, and evidences that payment was successfully received satisfying the purchase request. At step 590, the merchant process transmits the receipt to the customer using the customer's electronic address that the merchant previously received. FIG. 5 processing thereafter ends at 595.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, implemented by an information handling system that includes a processor and a memory accessible by the processor, the method comprising:
receiving, at a merchant, a purchase request that includes a purchase amount;
creating a payment template that includes the purchase amount and one or more merchant bank account identifiers;
providing the payment template to a customer; and
receiving, at the merchant, a notification of a completion of the purchase request from a trusted third party.

2. The method of claim 1 wherein the notification is received within a predetermined amount of time after providing the payment template, with the predetermined amount of time being less than one minute.

3. The method of claim 1 wherein the merchant is inhibited from receiving any customer account information that could be used to initiate payment to the merchant from the customer.

4. The method of claim 1 further comprising:
generating a first merchant reference number that is included in the payment template, wherein a second merchant reference number is included in the received notification, and wherein the completion of the purchase is determined by matching the first merchant reference number and the second merchant reference number.

5. The method of claim 1 wherein the trusted third party is a first financial institution utilized by the merchant that received payment from a second financial institution utilized by the customer.

6. The method of claim 1 wherein the payment template is provided to the customer by wirelessly transmitting the payment template to a mobile customer computing device utilized by the customer.

7. The method of claim 6 further comprising:
wirelessly transmitting a receipt from the merchant to the customer's mobile customer computing device.

8. An information handling system comprising:
one or more processors;
a memory coupled to at least one of the processors; and
a set of instructions stored in the memory and executed by at least one of the processors to perform actions comprising:
receiving, at a merchant, a purchase request that includes a purchase amount;
creating a payment template that includes the purchase amount and one or more merchant bank account identifiers;
providing the payment template to a customer; and
receiving, at the merchant, a notification of a completion of the purchase request from a trusted third party.

9. The information handling system of claim 8 wherein the notification is received within a predetermined amount of time after providing the payment template, with the predetermined amount of time being less than one minute.

10. The information handling system of claim 8 wherein the merchant is inhibited from receiving any customer account information that could be used to initiate payment to the merchant from the customer.

11. The information handling system of claim 8 wherein the actions further comprise:
generating a first merchant reference number that is included in the payment template, wherein a second merchant reference number is included in the received notification, and wherein the completion of the purchase is determined by matching the first merchant reference number and the second merchant reference number.

12. The information handling system of claim 8 wherein the trusted third party is a first financial institution utilized by the merchant that received payment from a second financial institution utilized by the customer.

13. The information handling system of claim 8 wherein the payment template is provided to the customer by wirelessly transmitting the payment template to a mobile customer computing device utilized by the customer.

14. The information handling system of claim 13 wherein the actions further comprise:
wirelessly transmitting a receipt from the merchant to the customer's mobile customer computing device.

15. A computer program product comprising:
a computer readable storage medium comprising a set of computer instructions, the computer instructions effective to perform actions comprising:
receiving, at a merchant, a purchase request that includes a purchase amount;
creating a payment template that includes the purchase amount and one or more merchant bank account identifiers;
providing the payment template to a customer; and
receiving, at the merchant, a notification of a completion of the purchase request from a trusted third party.

16. The computer program product of claim 15 wherein the notification is received within a predetermined amount of time after providing the payment template, with the predetermined amount of time being less than one minute.

17. The computer program product of claim 15 wherein the merchant is inhibited from receiving any customer account information that could be used to initiate payment to the merchant from the customer.

18. The computer program product of claim 15 wherein the actions further comprise:
generating a first merchant reference number that is included in the payment template, wherein a second merchant reference number is included in the received notification, and wherein the completion of the purchase is determined by matching the first merchant reference number and the second merchant reference number.

19. The computer program product of claim 15 wherein the trusted third party is a first financial institution utilized by the merchant that received payment from a second financial institution utilized by the customer.

20. The computer program product of claim 15 wherein the payment template is provided to the customer by wirelessly transmitting the payment template to a mobile customer computing device utilized by the customer.
